(19) United States
(12) Patent Application Publication
(10) Pub. No.: US 2026/0268724 A1
(43) Pub. Date: Sep. 10, 2026

(54) IDENTIFYING ELECTRONIC DEVICES USING TEMPORALLY CHANGING INFORMATION

(71) Applicant: ecoATM, LLC, San Diego, CA (US)

(72) Inventors: Babak Forutanpour, San Diego, CA (US); Ted Ray Gooding, San Diego, CA (US); Derchang Chao, San Diego, CA (US); Mazen Labban, San Diego, CA (US)

(21) Appl. No.: 19/377,504

(22) Filed: Nov. 3, 2025

Related U.S. Application Data
(63) Continuation of application No. 17/811,548, filed on Jul. 8, 2022, now Pat. No. 12,462,635.
(60) Provisional application No. 63/220,381, filed on Jul. 9, 2021.
(60) Provisional application No. 63/220,890, filed on Jul. 12, 2021.

(51) Int. Cl. G07F 9/00; G06Q 10/30; G06Q 20/18; G06Q 30/0283; G07F 7/06

(52) U.S. Cl. CPC G07F 9/009; G06Q 10/30; G06Q 20/18; G07F 7/06; G06Q 30/0283

(57) ABSTRACT

Described are systems and methods to verify the identity of an evaluated device that has been previously identified and evaluated remotely from a reader device. The reader device obtains from an evaluated device temporally changing information, where the temporally changing information includes a unique identifier associated with the evaluated device and a proximity indication. The reader device verifies the temporally changing information by verifying that the unique identifier is contained in the temporally changing information, that the unique identifier is stored in a database associated with the reader device, and that the temporally changing information includes the proximity indication indicating that the evaluated device and the reader device are proximate to each other. Upon verifying the temporally changing information, the reader device obtains the price of the evaluated device, based on the unique identifier associated with the evaluated device. Upon obtaining the price of the evaluated device, the system compensates a user associated with the evaluated device.

### CROSS-REFERENCE TO RELATED APPLICATION(S)

This application is a continuation of U.S. patent application Ser. No. 17/811,548, filed Jul. 8, 2022 (attorney docket no. 111220.8062.US 02), which claims the benefit of U.S. Provisional Patent Application No. 63/220,381, filed Jul. 9, 2021 (attorney docket no. 111220.8062.US 00), and U.S. Provisional Patent Application No. 63/220,890, filed Jul. 12, 2021 (attorney docket no. 111220.8062.US 01), all of which are incorporated by reference in their entireties herein.

### TECHNICAL FIELD

The present disclosure is directed generally to methods and systems for evaluating and recycling mobile phones and other consumer devices and, more particularly, to hardware and/or software for facilitating device identification, evaluation, purchase, and/or other processes associated with electronic device recycling.

### BACKGROUND

Electronic devices, such as mobile phones, laptop computers, notebooks, tablets, PDAs, MP3 players, wearable smart devices, etc., are ubiquitous. Currently there are over 14 billion mobile devices in use in the world. In other words, there are more mobile devices in use than there are people on the planet. Part of the reason for the rapid growth in the number of consumer electronic devices is the rapid pace at which these devices evolve, and the increased usage of such devices in Third World countries.

As a result of the rapid pace of development, a relatively high percentage of electronic devices are replaced every year as consumers continually upgrade their mobile phones and other electronic devices to obtain the latest features or a better operating plan. According to the U.S. Environmental Protection Agency, the United States alone disposes of over 370 million mobile phones, PDAs, tablets, and other electronic devices every year. Millions of other outdated or broken mobile phones and other electronic devices are simply tossed into junk drawers or otherwise kept until a suitable disposal solution arises.

Although many electronic device retailers and cell carrier stores now offer mobile phone trade-in or buyback programs, many old mobile phones still end up in landfills or are improperly disassembled and disposed of in developing countries. Unfortunately, however, mobile phones and other electronic devices typically contain substances that can be harmful to the environment, such as arsenic, lithium, cadmium, copper, lead, mercury, and zinc. If not properly disposed of, these toxic substances can seep into groundwater from decomposing landfills and contaminate the soil with potentially harmful consequences for humans and the environment.

As an alternative to retailer trade-in or buyback programs, consumers can also recycle, exchange, and/or sell their used mobile phones using self-service kiosks located in malls, retail stores, or other publicly accessible areas. Such kiosks are operated by ecoATM, LLC, the assignee of the present application, and aspects of these kiosks are described in, for example: U.S. Pat. Nos. 7,881,965, 8,195,511, 8,200,533, 8,239,262, 8,423,404, and 8,463,646, which are incorporated herein by reference in their entireties.

There continues to be a need for improving the means available to consumers for recycling or reselling their mobile phones and other electronic devices. Simplifying the recycling/reselling process, enhancing the consumer experience, and discouraging fraud can incentivize consumers to dispose of their old electronic devices in an efficient and environmentally conscientious way.

### BRIEF DESCRIPTION OF THE DRAWINGS

FIG. 1 shows a user interface presented by a mobile application to enable a user to evaluate and recycle/sell/exchange a mobile phone or other electronic device, in accordance with some embodiments of the present technology.

FIG. 2 is a partially schematic isometric view of a kiosk for recycling and/or other processing of mobile phones and other electronic devices, in accordance with some embodiments of the present technology.

FIG. 3 shows an evaluator device evaluating an evaluated device, in accordance with some embodiments of the present technology.

FIG. 4 shows a user interface presented by a mobile application to initiate generation of temporally changing information, in accordance with some embodiments of the present technology.

FIGS. 5A-5C show examples of temporally changing information, in accordance with some embodiments of the present technology.

FIG. 6 is a flowchart of a method to determine whether a device has been previously evaluated, according to some embodiments of the present technology.

FIG. 7 is a block diagram that illustrates an example of a computing system in which at least some operations described herein can be implemented, in accordance with some embodiments of the present technology.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The following disclosure describes various embodiments of hardware and/or software systems and methods that facilitate the identification, evaluation, purchase, and/or other processes associated with recycling of mobile phones and/or other electronic devices.

In various embodiments, for example, the systems and methods described in detail herein enable a user to evaluate a condition of a mobile phone or other electronic device (an “evaluated device”), and enable a kiosk or other “reader” device to properly identify the electronic device when it is presented to the reader device for sale or other processing. Examples of electronic devices include, but are not limited to all manner of mobile phones; smartphones; handheld devices; personal digital assistants (PDAs); tablets; MP3 or other digital music players; notebooks, Ultrabooks and laptop computers; e-readers; all types of cameras; larger consumer electronic devices, such as desktop computers; etc. Upon evaluation of the electronic device, the system can determine an estimated price for the evaluated device and present the estimated price to the user. If the user accepts the price, the user can present the evaluated device to a reader device (e.g., a kiosk for recycling electronic devices) that verifies that the presented device is the one previously evaluated. Upon verification, the user can submit the evaluated device for sale, exchange, return, donation, etc.

To prevent the user from remotely evaluating a first device and then presenting a second device (e.g., a less valuable second device) for sale in place of the originally evaluated first device, the system implements temporally changing information that enables a reader device to confirm the identity of the presented device. Examples of reader devices include, but are not limited to kiosks, mobile phones and other electronic devices, and so on. The reader device can obtain the temporally changing information from the presented device, where the temporally changing information can include a set of periodically or otherwise temporally changing indicia.

In some embodiments, an indicator in the set of temporally changing indicia is based on a prior indicator in the set of temporally changing indicia. Examples of indicia types include, but are not limited to one or more of: QR codes; bar codes; audio information; visual information; video information; electromagnetic information; such as radiofrequency information; infrared information; vibration information (e.g., vibration pattern(s)); and so on. In some embodiments, an indicator comprises a collection of two or more different indicia types. For example, an indicator in the set of temporally changing indicia can comprise a QR code and a high-frequency audio signal.

Each indicator in the set of temporally changing indicia can include, for example, a unique identifier associated with the evaluated device and a proximity indication that the evaluated device is proximate to the reader device (e.g., positioned directly in front of the reader device). The reader device verifies a subset of indices in the set of temporally changing indicia by performing one or more of the following steps: The reader device obtains an indicator and a prior occurring indicator (e.g., the previous index) in the set of temporally changing indicia. The reader device verifies that both indicia include the same unique identifier value. The reader device can also verify that the unique identifier value is stored in a database associated with the reader device. If the unique identifier is not stored in the associated database, the reader device determines that the evaluated device has not been previously evaluated. Conversely, if the unique identifier is stored in the associated database, then the reader device determines that the evaluated device has been previously evaluated. The reader device can then verify that the presented device is located proximate to the reader device by verifying that both indicia contain a proximity indication that the evaluated device is proximate to the reader device. Finally, the reader device verifies that the indicator in the set of temporally changing indicia is based on one or more prior indicia in the set of temporally changing indicia. Upon verifying the identity of the evaluated device, the reader device can then obtain a price of the evaluated device and facilitate payment of compensation to the user associated with the device, after the user submits the device for resale/recycling/exchange, etc.

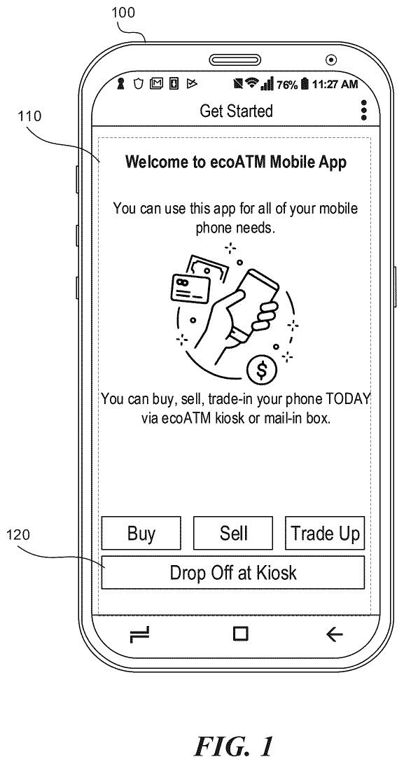

Certain details are set forth in the following description and in FIGS. 1-7 to provide a thorough understanding of various embodiments of the present technology. In other instances, well-known structures, materials, operations, and/or systems often associated with smartphones and other handheld devices, consumer electronic devices, computer hardware, software, and network systems, etc., are not shown or described in detail in the following disclosure to avoid unnecessarily obscuring the description of the various embodiments of the present technology. Those of ordinary skill in the art will recognize, however, that the present technology can be practiced without one or more of the details set forth herein, or with other structures, methods, components, and so forth.

The terminology used below is to be interpreted in its broadest reasonable manner, even though it is being used in conjunction with a detailed description of certain examples of embodiments of the present technology. Indeed, certain terms may even be emphasized below; however, any terminology intended to be interpreted in any restricted manner will be specifically defined as such in this Detailed Description section.

The accompanying Figures depict embodiments of the present technology and are not intended to be limiting of its scope. The sizes of various depicted elements are not necessarily drawn to scale, and these various elements may be arbitrarily enlarged to improve legibility. Component details may be abstracted in the Figures to exclude details such as position of components and certain precise connections between such components when such details are unnecessary for a complete understanding of how to make and use the invention.

In the Figures, identical reference numbers identify identical, or at least generally similar, elements. To facilitate the discussion of any particular element, the most significant digit or digits of any reference number refers to the Figure in which that element is first introduced. For example, element 100 is first introduced and discussed with reference to FIG. 1.

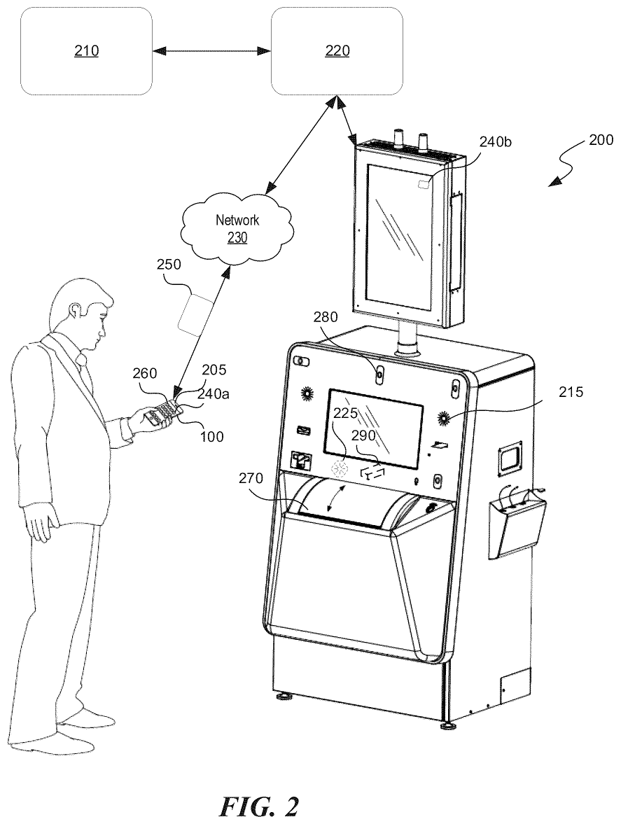

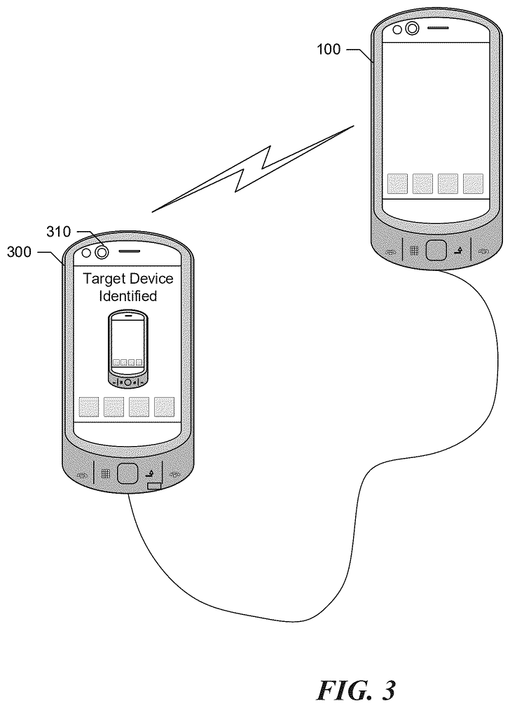

FIG. 1 shows a user interface presented by a schematically shown mobile application 110 to enable a user to evaluate and recycle/self/exchange an electronic device (e.g., a mobile phone), in accordance with some embodiments of the present technology. For example, a user in possession of an electronic device 100, that the user wants to recycle, sell, or exchange via a reader device, can download the mobile application onto the device 100. The reader device can be, for example, an automated kiosk (e.g., the kiosk 200 in FIG. 2), or another electronic device (e.g., “the evaluator device” 300 in FIG. 3).

Once downloaded at the electronic device 100, the application can receive and record input from the device 100 and/or the user regarding the user and/or the device 100 characteristics. For example, the application 110 can record the International Mobile Equipment Identity (IMEI), serial number, and/or other unique identifiers 260 of FIG. 2 from the evaluated device 100. The unique identifier 260 can include a subscriber identity module (SIM) number associated with the evaluated device, an International Mobile Subscriber Identity (IMSI), a Mobile Subscriber ISDN Number (MSISDN). The user can also be instructed to perform one or more tests, such as touchscreen, display, global positioning system (GPS), microphone, and/or speaker tests, while the application is active on the device 100 to capture the device's make, model, device condition, and so on. The application 110 can use the captured data to generate a price quote based on the make, model, condition, and any additional identified characteristics from the evaluated device 100.

If the user accepts the offer presented by the application, the user is given a menu of options, which can include a list of nearby reader devices (e.g., the kiosk 200, the evaluator device 300, etc.) along with instructions on how to present the device to the reader device to complete a sale/exchange/recycle transaction. The instructions can prompt the user to visit one of the kiosk 200 of their choosing, and while present at the kiosk, to activate the application. Alternatively, if the user is in the process of presenting the device 100 to the operator of the evaluator device 300, the instructions can prompt the user to activate the application at that time. Alternatively, an option in the menu of options displayed by application can instruct the user to provide the device 100 to an operator of the evaluator device 300 so that the operator of the evaluator device 300 can activate the application. In another embodiment, the application 110 can notify a third party, for example, a “phone collector,” to collect the device 100 from the user. The phone collector can collect one or more devices 100 from one or more users and can sell/exchange/recycle one or more devices 100 at the same time by bringing them to a kiosk 200. With reference to FIG. 2, in some embodiments the kiosk 200 can include one or more internal cameras 290 that can read multiple device display screens at once while inside the kiosk 200 to facilitate evaluation of multiple devices 100. In this embodiment, the user can be paid electronically through an associated account.

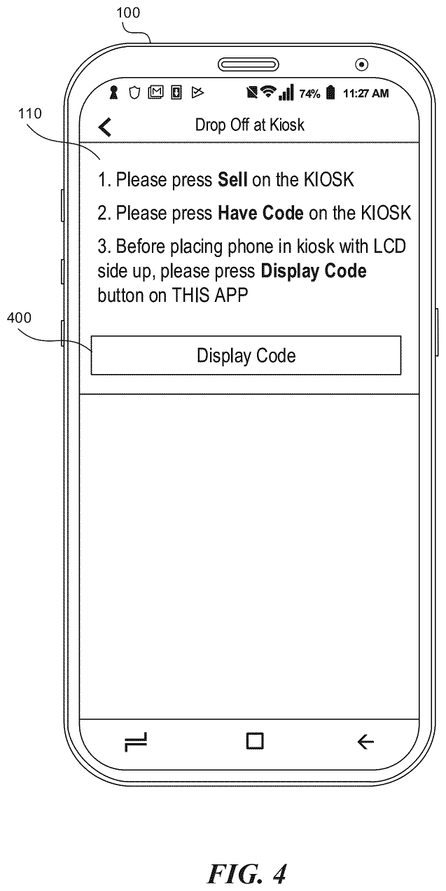

Returning to FIG. 1, in any of the embodiments described above, the application 110 can present an option 120 to enable the user to submit the device to a kiosk or other evaluator device. Upon selecting option 120, the application can display a user interface as illustrated in FIG. 4. The terms “reader device” and “evaluator device” are used interchangeably herein.

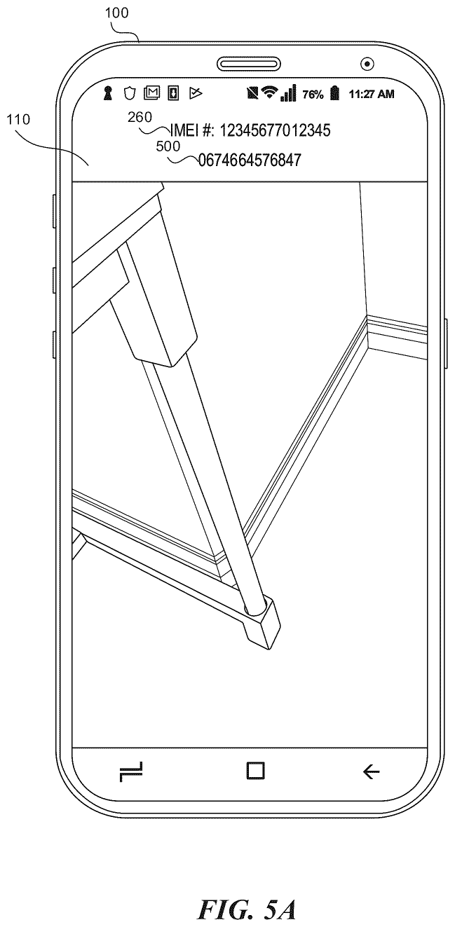

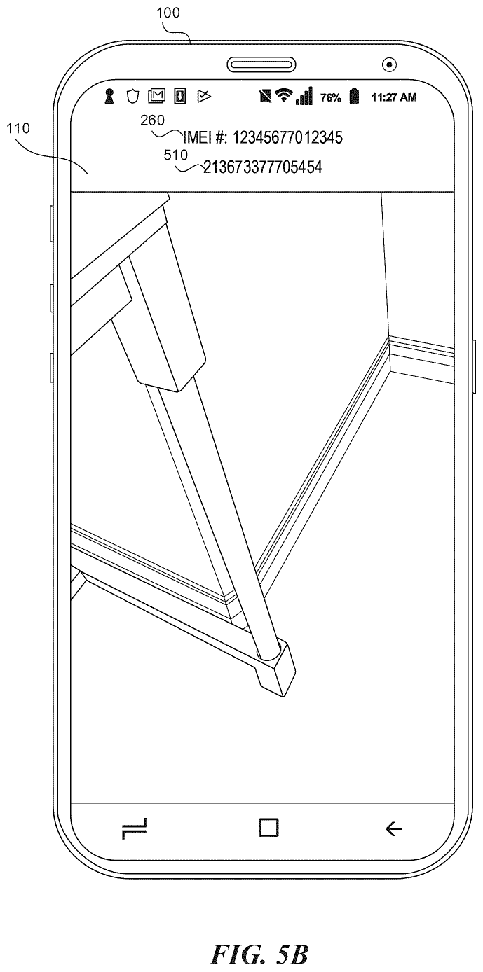

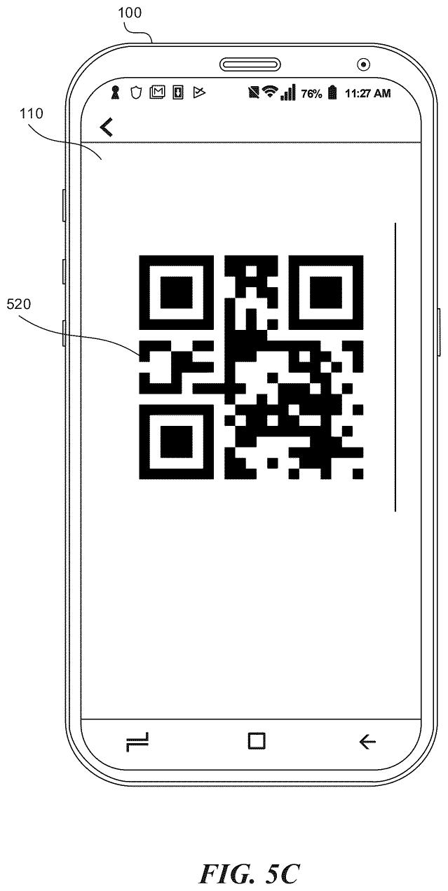

FIG. 4 shows a user interface to guide a user to submit the device 100 to an evaluator device, in accordance with some embodiments of the present technology. The user interface illustrated in FIG. 4 guides a user through a series of steps to interact with the evaluator device (e.g., the kiosk 200) before the user can submit the device to the evaluator device. Upon selecting option 400 on the user interface of application 110, the application 110 can cause the device to present temporally changing information. For example, the application can cause the device to display one or more QR codes. In another example, the application can cause the device to emit one or more audio signals. In another example, the application can cause the device to present a video with audio and/or visual information. The temporally changing information comprises a set of temporally changing indicia, as discussed above. Each indicator in the set of temporally changing indicia can be machine-readable, human-readable, or both. For example, the temporally changing information comprises a sequence of QR codes 520 (FIG. 5C) that change over time. In another example, the temporally changing information comprises a series of visible codes. The visible codes can include an image that has been imperceptibly modified to include the temporally changing information. For example, an image shown on the display of the device 100 can include embedded information such as text or graphics indicating the code. The embedded information can be imperceptible to a human observer; however, the information can be detected by a reader device, e.g., the kiosk 200 in FIG. 2 or the evaluator device 300 in FIG. 3.

FIGS. 5A-5C show temporally changing information, in accordance with some embodiments of the present technology. The temporally changing information shown in FIGS. 5A-5C includes indicia 500, 510, 520, respectively, shown on the display screen of the device 100. The indicia 500, 510, 520 showing on the display screen of the device 100 refreshes periodically at particular intervals, for example, every 2 seconds, 10 seconds, etc. The user can present the device 100 to the reader device 200, 300 with the indicia 500, 510, 520 showing on the device screen. The interval duration for displaying the indicia and/or the number of intervals to be evaluated can depend on one or more factors, such as cost of the device, geographic location of device/user, telecommunications carrier associated with the device, prior history of user of the device, time of year (e.g., holidays, summer, etc.), and so on. For example, simpler and shorter intervals can be selected for device types assessed to be less valuable. As another example, for a low value device (e.g., valued at <$50) the reader device (e.g., kiosk) may only look for 1 interval, whereas for a high-value device (e.g. valued at >$250), the reader device would wait for at least four intervals to match in a continuous 20 seconds time period before proceeding with the transaction.

The temporally changing information can be encoded using various communication signals such as an audio signal, a magnetic signal, an electromagnetic polarization signal, a tactile signal, an electromagnetic signal, etc. The reader device 200, 300 can acquire the temporally changing information from the device using appropriate sensors/readers 205, 215 in FIG. 2 such as cameras, microphones, polarized light detectors, magnetic sensors, tactile sensors, antennas, etc. Labels 205, 215 can represent various sensors as described above such as cameras, microphones, polarized light detectors, magnetic sensors, tactile sensors, antennas. The reader device 200, 300 can enable and/or disable one or more sensors/readers based on the indicia type included in the temporally changing information. For example, if the temporally changing information is an infrared electromagnetic signal, the reader device 200, 300 can acquire the information using one or more infrared antennas, receivers, etc. If the temporally changing information is encoded using light polarization, the reader device 200, 300 can acquire the information using one or more polarized light detectors. If the temporally changing information is encoded using a magnetic signal, the reader device 200, 300 can acquire the information using one or more magnetic sensors. If the temporally changing information is encoded using an electromagnetic signal, the reader device 200, 300 and the device 100 can communicate using Wi-Fi, radiofrequency, infrared frequency, cellular telecommunication network, etc.

If the temporally changing information is encoded using an image format, such as a QR code, or video, the reader device 200, 300 can acquire the information using one or more cameras. For example, when the reader device is the kiosk 200, the one or more of the kiosk's external or internal cameras 280, 290 in FIG. 2 can read the temporally changing information 500, 510, 520 shown on the device 100. If the kiosk's external camera 280 reads the indicia 500, 510, 520, the kiosk 200 can open a door 270 enabling the user to place the device 100 in the inspection area of the kiosk for further evaluation and/or confirmation of the condition of the device 100 and, if appropriate, remuneration of the user. As another example, when the reader device is an evaluator device 300, the evaluator device cameras 310 can read the temporally changing information 500, 510, 520 shown on the device 100. The evaluator device 300 can verify the temporally changing information 500, 510, 520, as described in this application, and can provide a notification to the user of the evaluator device that the device 100 has been verified and can be collected.

The reader device 200, 300 can acquire one or more information samples of the temporally changing information from the device. For example, the reader device 200, 300 can take a single picture or video of the indicia 500, 510, 520, thus recording only a single indicator in the temporally changing information. The number of information samples can depend on one or more factors, such as the expected price of the evaluated device, the attributes of the device (e.g., make, model, telecommunications service provider, and so on), location of the evaluator device, type of evaluator device (e.g., kiosk 200 or electronic device 300), attributes of evaluator device, pattern(s) of consumer behavior, and so on.

Based on the single indicator 500, the reader device 200, 300 can determine whether the single indicator contains the necessary authentication information. For example, the necessary authentication information can include a unique identifier 260 associated with the device (examples discussed above) and a proximity indication that the device is proximate to the reader device 200, 300. The reader device 200, 300 can compare unique identifier information gleaned from the temporally changing information 500, 510, 520 against stored information (e.g., information retrieved from a remote database 210 in FIG. 2) to confirm that the device 100 has previously been evaluated by a user via the mobile application 110. In some embodiments, when the device 100 is in the vicinity (e.g., within a threshold distance) of the reader device 200, 300, one or more of the following can be visible on the display screen of the device 100: the date/time, the IMEI or hardware ID, or the temporally changing information 500, 510, 520. If the reader device is a kiosk 200, the device 100 can be placed inside the inspection area of the kiosk when displaying this information (e.g., the date/time, the IMEI or hardware ID, and/or the temporally changing information 500, 510, 520). Alternatively, the device 100 can also be positioned in front of the kiosk camera 280 when displaying the above information. In other words, the kiosk 200 can use either the external camera 280 (and/or other sensor) or the internal camera 290 (and/or other sensor) to determine whether the single indicator contains the necessary authentication information.

The proximity indication that the device 100 is proximate to the reader device 200 can be based on one or more factors, such as the date/time, ambient temperature, GPS coordinates, ambient air pressure, Wi-Fi identifier of the reader device 200, 300, a locally generated signal, ambient noise signal, ambient illumination signal, body heat signature, or other parameters that are contemporaneously common to the device and the reader device. In some embodiments, the proximity indication 240 is a value 240a, that can be measured independently by the device 100 and a value 240b, that can be measured independently by the reader device 200, 300. The reader device 200, 300 can determine a match between the proximity indications 240a and 240b within a specified tolerance. For example, if the temporally changing information 500, 510, 520 produced by the device 100 specifies a time of 2:22:20 p.m. (e.g., proximity indication 240a), while the reader device 200, 300 has a time of 2:22:27 p.m. (e.g., proximity indication 240b), the reader device can obtain the tolerance, which can be 10 seconds. Since 2:22:20 p.m. and 2:22:27 p.m. are within 10 seconds of each other, the reader device 200, 300 can determine that the reader device and the device 100 are proximate to each other.

The proximity indication that the device 100 is proximate to the reader device 200, 300 (“proximity indication” 240a, 240b) is important to avoid fraud. For example, in an attempt to cheat the system, a user can record a video of temporally changing information comprising a price quote of a first device and try to use that video to sell a lower quality second device. The reader device 200, 300 can detect the attempted fraud because the temporally changing information presented via the video displayed on the second device comprises a proximity indication that the expensive first device was proximate to the reader device 200, 300, not that the cheaper second device is currently proximate to the reader device. Consequently, the reader device will fail to identify the second device and thus reject the second device.

For example, the proximity indication 240 can include a current timestamp. If the temporally changing information 500, 510, 520 includes the time when the more expensive device was proximate to the reader device 200, 300, the reader device can detect, at the time of the attempted fraud, that the time in the temporally changing information does not match the current time. Similarly, if the proximity indication 240 includes the current ambient temperature and/or current air pressure, the reader device 200, 300 can detect a discrepancy between the ambient temperature and/or air pressure in the temporally changing information 500, 510, 520 and the currently measured ambient temperature and/or air pressure. Consequently, the reader device 200, 300 can refuse to accept the device 100. Similarly, the proximity indication 240 can be GPS coordinates. The reader device 200, 300 can be mobile, and the location of the reader device can change. Consequently, the user attempting to commit fraud can record temporally changing information containing GPS coordinates of the reader device 200, 300, when the reader device 200, 300 was located at a different location. Alternatively, there can be multiple reader devices 200, 300, and the user attempting to commit fraud could have recorded temporally changing information containing GPS coordinates of a different reader device. When the user tries to submit false temporally changing information containing incorrect GPS coordinates to the reader device 200, 300, the reader device 200, 300 can refuse to accept the device because the GPS coordinates contained in the temporally changing information do not match the GPS coordinates of the reader device.

In another example, the proximity indication 240 can include a currently generated signal that is locally available. Either the reader device 200, 300 or the device 100 can generate the communication signal. The communication signal can take on various forms, as described in this application. The other device can record the signal and extract information from the signal. The other device can include the extracted information in the temporally changing information 500, 510, 520. For example, the reader device 200, 300 can make a sound at a frequency such as 1500 Hz. The device can determine the frequency of the sound and include the determined frequency in the indices 500, 510, 520. The frequency of the sound can change to deter fraud. In another example, either the reader device 200, 300 or the device 100 can show a visual index. The device 100 can include a number obtained from the visual indicator and the indicia 500, 510, 520 presented to the reader device 200, 300. The reader device 200, 300 can verify that the temporally changing information 500, 510, 520 contains the correct number.

Several additional examples of fraud, such as attack scenarios and their prevention, are disclosed below. In a first example, a user attempting to commit fraud can obtain a high-value device and a device 100 that is cheaper than the high-value device. In the high-value device, the user can disable automatic date and time, set the system time for 1 minute in the future, and display the temporally changing information. This gives the user 1 minute to trade in the device 100 in place of the high-value device. On the device 100, the user can record and play back the video of the temporally changing information 500, 510, 520 that was displayed on the high-value device. To prevent this type of attack, the application 110 running on the high-value device can use GPS time instead of system time, thus rendering any tampering with the system time useless. When obtaining a GPS signal indoors may be difficult, the application 110, instead of obtaining the GPS time, can detect that the user has disabled automatic date/time and can refuse to generate the temporally changing information 500, 510, 520.

In a second example, a user attempting to commit fraud can have the high-value device display the temporally changing information 500, 510, 520, and the device 100 can mirror the display of the high-value device screen. To prevent mirroring, the reader device 200, 300 can perform operations to ensure that the device screen is responsive while showing the temporally changing information 500, 510, 520. For example, the kiosk dome lighting 225 can emit a flash to ensure that the device screen darkens in response to the lighting. By contrast, when the device screen is in mirror mode, the device screen would not adjust brightness in response to the flash.

In a third example, a user attempting to commit fraud can create an application to display QR codes of high-value devices on the device 100. To avoid re-creation of the temporally changing information algorithm, the server 220 can transmit a universally unique identifier (UUID) 250 and an encryption key via a secure network connection 230 in FIG. 2 to the application 110. The UUID 250 can be unique to the device 100.

The UUID 250 is a 128-bit or 256-bit label used for information in computing systems. When generated according to the standard methods, UUIDs are, for practical purposes, unique. Their uniqueness does not depend on a central registration authority or coordination between the parties generating them, unlike most other numbering schemes. While the probability that a UUID will be duplicated is not zero, it is close enough to zero to be negligible. Thus, anyone can create a UUID 250 and use it to identify something with near certainty that the identifier does not duplicate one that has already been, or will be, created to identify something else. Information labeled with UUIDs by independent parties can therefore be later combined into a single database or transmitted on the same channel, with a negligible probability of duplication. The UUID 250 and encryption key can expire after one use or five days (two-day expiration plus a three-day grace period).

The temporally changing information 500, 510, 520 can be encrypted with an encryption key and can include the UUID 250 and the proximity indication 240. The proximity indication 240 and the UUID 250 can be 256 to 512 encrypted bytes long.

The reader device 200, 300 can perform an additional verification that the UUID 250 belongs to the device 100. When the server 220 generates the UUID to send to the device 100, the server can record the type of device to which the UUID 250 is sent. The type of the device can be iPhone® 10, Android®, etc. Each type of device has a specific width, height, and curvature. The server 220 can store the device dimensions in the database 210 along with the UUID 250. When the reader device 200, 300 receives the device 100, the reader device 200, 300 can confirm device dimensions such as width, height, and/or curvature to make sure that the device dimensions match the device dimensions stored in the database 210. If the dimensions of the device 100 received at the reader device 200, 300 do not match the expected dimension stored in the database 210, the reader device can refuse to accept the device. If the reader device 200, 300 verifies the UUID 250 incorrectly, subsequently, a UUID of each device received at the reader device 200, 300 can be verified by a human operator.

The application 110 can combine the unique identifier 260 associated with the device 100, the proximity indication 240, and/or the UUID 250 to generate temporally changing information 500, 510, 520. For example, to generate the temporally changing information, the application 110 can interleave the digits of the unique identifier 260 and the proximity indication 240. In a more specific example, the unique identifier 260 can be the IMEI, which is 15 digits, and the proximity indication 240 can be the current time including two digits representing the hour and two digits representing the minutes. Consequently, to interleave the unique identifier 260 and the proximity indication 240, the application 110 can put a digit of the proximity indication 240 after every 4 digits of the unique identifier 260, until the end is reached. For example, if the unique identifier 260 is 012345678901234 and the proximity indication 240 is 0123, the interleaved representation (with the proximity indication digits in bold and underlined) can be 0123045671890122343. Other interleaving algorithms are possible. For example, the digits of the unique identifier 260 are located at predetermined positions such as the last four positions, first, sixth, seventh, and eleventh positions, etc.

In addition to generating a single secure index, the application 110 can generate a set of temporally changing indicia 500, 510, 520, where one indicator value 510 in the set depends on a prior indicator value 500. The previous indicator 500 can be the immediately preceding indicia to the subsequent indicator 510. For example, the initial indicator value 500 in the set of temporally changing indicia 500, 510, 520 can be generated as described above. The indicator value 510 can be generated using the unique identifier 260, the proximity indication 240, and a number that depends on the previous indicator value 500. For example, the number can be the sum of the digits of the previous indicator value 500. The sum of all the digits of the previous indicator value 500 can be 2032. Consequently, the number 2032 is included in the indicator value 510 by, for example, interleaving the digits of the number 2032 into the indicator at predetermined locations. In another example, the number can be the previous indicator value 500 divided by 100, or the previous indicator value modulo 100. Consequently, the resulting number is included in the indicator value 510 by, for example, interleaving the digits of the resulting number into the indicator at predetermined locations.

As discussed above, the reader device 300 can use the camera 310, and the reader device 200 can use one or more of the cameras 280, 290, to obtain and record the temporally changing information 500, 510, 520. If the reader device is the kiosk 200, the reader device can use the external camera 280 to scan several instances of the indices 500, 510, 520 before inviting the user to put the device 100 inside the kiosk, where the kiosk can do further scanning of the device and the temporally changing information. In some embodiments, the user can press a button on the kiosk 200 to open the door 270 to the inspection area of the kiosk and place the device 100 inside the kiosk 200. Or, to avoid contact with the kiosk 200, the user can present valid indicia 500, 510, 520 to the external kiosk camera 280, and upon verifying one or more of the indicia the kiosk 200 can open the door 270 automatically.

In some embodiments, the device 100 can be factory reset upon being evaluated remotely from the reader device 200, 300, and thus cannot present the temporally changing information 500, 510, 520 to the reader device. To resolve this problem, the server 220 can transmit (e.g., via email, text, or other means) a set of temporally changing indicia to the user, and the user can present one or more indicia from the received set on a different device. In another embodiment, when the device 100 reboots, upon factory reset, the device can present an option to a user, which upon selection presents the temporally changing information 500, 510, 520 to the reader device 200, 300.

After successfully verifying the identity of the device, one or more further acts can be performed to submit the device to the reader device. For example, when the reader device is a kiosk 200, the kiosk 200 can instruct the user to place the device 100 in the internal inspection area of the kiosk 200, which can run additional visual inspections via the internal cameras 290 to confirm that the desired device 100 has been placed inside the kiosk 200 an to evaluate, e.g., the condition of the device display screen (e.g. an LCD), etc. The kiosk 200 can take at least two additional pictures of the LCD while the application 110 is running, to confirm the expected indicia 500, 510, 520 is visible. Not only can the kiosk 200 evaluate the device display screen glass to see if the glass is cracked, but the kiosk can also grade the LCD that's underneath the glass. To grade the LCD, the kiosk 200 can detect water damage, which makes the LCD pinkish, the kiosk can detect hot pixels, which are always white, or the kiosk can detect cold pixels, which are always black. Such kiosks are operated by ecoATM, LLC, the assignee of the present application, and aspects of these kiosks are described in, for example: U.S. patent Ser. No. 15/195,828, Ser. No. 16/357,041, Ser. No. 17/137,261, Ser. No. 15/130,851, Ser. No. 15/176,975, Ser. No. 16/794,009, 63/070,207 which are incorporated herein by reference in their entireties.

As another example, when the reader device is the evaluator device 300, the evaluator device can use the camera 310 of the evaluator device 300 to run an additional visual inspection of the device 100. For example, the evaluator device 300 can take at least two additional pictures of the LCD while the application 110 is running on the screen, to confirm the expected indicia 500, 510, 520 is visible. Not only can the evaluator device 300 grade the glass to see if the glass is cracked, but the evaluator device can also grade the LCD that's underneath the glass. To grade the LCD, the evaluator device 300 can detect water damage, which makes the LCD pinkish, the evaluator device can detect hot pixels, which are always white, or the evaluator device can detect cold pixels, which are always black.

The application 110 can contain software to ensure that the device screen does not go to “sleep” during further evaluation and can also increase the brightness of the screen to improve visibility.

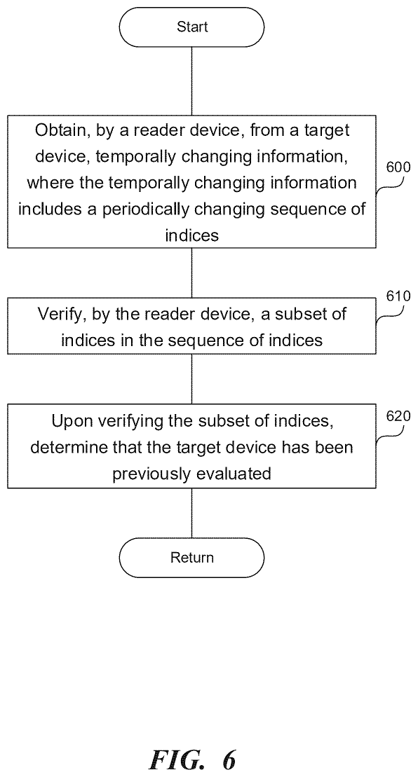

FIG. 6 is a flowchart of a method 600 to determine whether a device has been previously evaluated, according to another embodiment of the present technology. In block 610, the processor can obtain, by the reader device, from an evaluated device, temporally changing information, where the temporally changing information includes a periodically changing sequence of indicia. Each indicator in the sequence of indices can include a unique identifier associated with the evaluated device, described in this application, and a proximity indication that the evaluated device is proximate to the reader device (“proximity indication”). An indicator in the sequence of indices can be based on a previous indicator in the sequence of indices. The unique identifier can be associated with the price of the evaluated device. The unique identifier can include an IMEI associated with the evaluated device, a UUID, or a model number associated with the evaluated device. The reader device can include a kiosk, a mobile phone, a tablet, a laptop computer, a smartwatch, etc. The temporally changing information can be encoded using various communication signals, as described in this application.

The proximity indication can include a timestamp, GPS coordinates, an ambient temperature, a signal, and/or an ambient air pressure. The processor can measure or generate the proximity indication. For example, the processor can measure the timestamp, for example, current time, GPS coordinates, ambient temperature, and/or ambient air pressure. The processor can generate the communication signal. The communication signal can take on various forms, as described in this application. For example, the audio signal can be a subsonic or a supersonic audio signal that the reader device and the evaluated device can detect. When the signal is a visual signal, the reader device can display a QR code that both the evaluated device and the reader device can detect.

The processor can obtain the contents of the signal by, for example, detecting the signal, or by knowing how the signal was generated. The processor can generate the indicator based on the signal. For example, the generated audio signal can have a number encoded in it. The processor can extract the number and include the extracted number in the index. Similarly, the generated visual signal can include an alphanumeric string. The alphanumeric string can be hidden in an image or can be explicit in the image. The processor can extract the alphanumeric string and include the alphanumeric string in the index.

In block 620, the processor can verify, through the reader device, a subset of indices in the sequence of indices, where the subset of indices includes the previous indicator and the current index. To verify the subset of indices, the processor can obtain the previous indicator and the current indicator in the sequence of indices. The processor can verify that the unique identifier is contained in at least one of the previous indicators and the current index, that the unique identifier is stored in a database associated with the reader device, that at least one of the previous indicators and the current indicator contains the proximity indication, and that the indicator in the sequence of indices is based on the previous indicator in the sequence of indices.

Verifying that the indicator is based on the previous indicator enables the processor to verify that the evaluated device is not displaying a static image of a previously recorded valid index, and enables the processor to verify that the evaluated device is running the desired application that knows the secret algorithm for generating the sequence of indices. The reader device can verify multiple indices in a sequence such as 2, 3, 4 indices, etc. The higher the number of indices verified, the lower the likelihood that the evaluated device is fraudulent.

Alternatively, the processor can verify a single indicator value via the reader device. To verify the indicator value, the processor can verify that the unique identifier is contained in the index, that the unique identifier is valid (e.g., it is stored in a database associated with the reader device), and that the indicator includes the proximity indication that the device is proximate to the reader device. For example, by verifying that the unique identifier is contained in the indicator and that the unique identifier is stored in the database, the processor verifies that the device has been previously evaluated and is currently being traded in for payment. By verifying that the indicator includes the proximity indication that the device is proximate to the reader device, the processor verifies that the device is not playing back a previously recorded indicator from a different, more expensive device.

In block 630, upon verifying the subset of indices, the processor can determine that the evaluated device has been previously evaluated. The processor can obtain, through the reader device, the price of the evaluated device, based on the unique identifier associated with the evaluated device. For example, a database can store the unique identifier and the price offered to the user when the user remotely evaluated the evaluated device. In another example, the processor can retrieve the price previously offered to the user during the evaluated device evaluation. Upon obtaining the price of the evaluated device, the processor can facilitate compensation (e.g., funds, points, credits, and so on) to a user of the evaluated device. For example, the processor can facilitate transfer of funds (or other renumeration) through an electronic payment system, such as PayPal, to the user's account.

Upon obtaining the price of the evaluated device, the processor can compensate a user associated with the evaluated device by, for example, electronically transferring funds to the user, offering a cash payout to the user, offering credit, or any other way described in this application. The user can be the owner of the evaluated device, and/or the user can be the person submitting the evaluated device.

To increase the security of each indicator in the temporally changing information, the processor can interleave the unique identifier and the proximity indication. The unique identifier and the proximity indication can be a string of alphanumeric characters. The processor can obtain the unique identifier and the proximity indication and separate the unique identifier into a first group of characters, and the proximity indication into a second group of characters. The characters can be individual alphanumeric characters such as digits.

The processor can generate the indicator by interleaving the first group of characters and the second group of characters. The interleaving can be done by alternating every character, alternating every couple of characters, or putting the second group of characters at previously designated locations. The processor can check whether the generated indicator matches the index. If so, the processor can determine that the indicator is correct.

In another embodiment, instead of generating the index, the processor can obtain the interleaving algorithm, the unique identifier, and the proximity indication. The processor can check that the correct character is at the correct place based on the interleaving algorithm, the unique identifier, and the proximity indication.

To increase the security of the temporally changing information, the processor can base each indicator in the temporally changing information on a previous indicator in the temporally changing information. The processor can obtain the unique identifier, the proximity indication, and the previous index. The processor can create a short indicator based on the previous index. The short indicator can be the sum of characters, or the sum of digits of the previous index. If the previous indicator includes alphanumeric characters, the processor can represent the characters using American Standard Code for Information Interchange (ASCII) code, and can sum the ASCII representation. The short indicator can be the previous indicator modulo 100. The short indicator can be the sum of characters or the sum of digits of the previous indicator modulo 1000.

The processor can separate the unique identifier into a first group of characters, and the proximity indication into a second group of characters. The processor can generate the indicator by placing the first group of characters, the second group of characters, and the short indicator in predetermined character locations. For example, the processor can interleave the first group and the second group to obtain a representation and add the characters of the short indicator at the end of the representation. In another example, to generate the index, the processor can separate the short indicator into a third group of characters, and interleave the first, the second, and the third group of characters by putting the characters in predetermined locations.

The processor can further prevent fraud by including a UUID associated with the evaluated device in the index. The processor can obtain the UUID from the index. The processor can obtain a physical description associated with the UUID. For example, a database can store the UUID and the physical description of the UUID, such as the width, height, and/or curvature of the UUID. The processor can inspect the physical properties of the evaluated device to determine whether the physical properties of the evaluated device correspond to the physical description associated with the UUID. Similarly, the physical properties can include width, height, and/or curvature. Upon determining that the physical properties of the evaluated device correspond to the physical description associated with the UUID, the processor can verify the UUID. If the physical properties of the evaluated device do not match the physical description associated with the UUID, the processor can determine that the user is trying to commit fraud by substituting a cheaper device for a more expensive, previously evaluated device.

### Reader Devices

In some embodiments, the reader device is a kiosk 200 for recycling and/or other processing of mobile phones and other consumer electronic devices, such as that illustrated in FIG. 2. In some embodiments, the reader device is an electronic device 300 of a third party authorized to evaluate and/or identify the electronic device 100, such as that illustrated in FIG. 3. Elements of FIGS. 2 and 3 are described above with reference to FIG. 1. As discussed above, the reader device 200, 300 can be configured to check the temporally changing information presented by the electronic device 100. Once the reader device 200, 300 verifies the temporally changing information, the system facilitates the collection of the evaluated device 100 via the reader device. In some embodiments, the system further facilitates compensation to the user of the evaluated device. For example, the system can facilitate the kiosk 200 to dispense compensation in the form of cash/gift card/pre-loaded debit card, etc. to a user of the evaluated device. As another example, the system can facilitate a reader device 200, 300 to transfer funds through an electronic payment system, such as PayPal, to the user's account. The automated kiosk and the evaluator device are further described in the U.S. Provisional Application Ser. No. 63/070,207, filed on Aug. 25, 2020, and incorporated herein by reference in its entirety.

### Example Computing System

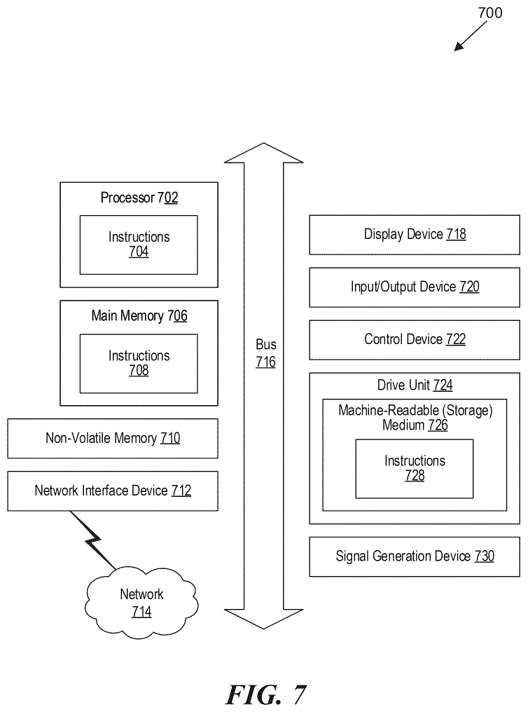

FIG. 7 is a block diagram that illustrates an example of a computing system 700 in which at least some operations described herein can be implemented. As shown, the computing system 700 can include: one or more processors 702, main memory 706, non-volatile memory 710, a network interface device 712, a video display device 718, an input/output device 720, a control device 722 (e.g., keyboard and pointing device), a drive unit 724 that includes a storage medium 726, and a signal generation device 730 that are communicatively connected to a bus 716. The bus 716 represents one or more physical buses and/or point-to-point connections that are connected by appropriate bridges, adapters, or controllers. Various common components (e.g., cache memory) are omitted from FIG. 7 for brevity. Instead, the computing system 700 is intended to illustrate a hardware device on which components illustrated or described relative to the examples of the Figures and any other components described in this specification can be implemented.

The processor 702 can perform the instructions described in this application, for example, the instructions described in FIG. 6. The processor 702 can be associated with the reader device 200 in FIGS. 2, 300 in FIG. 3, the server 220 in FIG. 2, and/or the evaluated device 100 in FIGS. 5A-5C. The main memory 706, the non-volatile memory 710, and/or the drive unit 724 can store instructions executed by the processor 702. A network 714 can be used to communicate between the database 210 in FIG. 2, the server 220, the kiosk 200, and/or the evaluated device 100.

The computing system 700 can take any suitable physical form. For example, the computing system 700 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 700. In some implementations, the computing system 700 can be an embedded computing system, a system-on-chip (SOC), a single-board computing system (SBC), or a distributed system such as a mesh of computing systems or include one or more cloud components in one or more networks. Where appropriate, one or more computing systems 700 can perform operations in real-time, near real-time, or in batch mode.

The network interface device 712 enables the computing system 700 to mediate data in the network 714 with an entity that is external to the computing system 700 through any communication protocol supported by the computing system 700 and the external entity. Examples of the network interface device 712 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 706, non-volatile memory 710, machine-readable medium 726) can be local, remote, or distributed. Although shown as a single medium, the machine-readable medium 726 can include multiple media (e.g., a centralized/distributed database and/or associated caches and servers) that store one or more sets of instructions 728. The machine-readable (storage) medium 726 can include any medium that is capable of storing, encoding, or carrying a set of instructions for execution by the computing system 700. The machine-readable medium 726 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices, removable flash memory, hard disk drives, optical discs, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 704, 708, 728) set at various times in various memory and storage devices in computing device(s). When read and executed by the processor 702, the instruction(s) cause the computing system 700 to perform operations to execute elements involving the various aspects of the disclosure.

Embodiments of the kiosk 200 and various features thereof can be at least generally similar in structure and function to the systems, methods, and corresponding features described in the following patents and patent applications, which are incorporated herein by reference in their entireties: U.S. Pat. Nos. 11,080,672, 10,860,990, 10,853,873, 10,572,946, 10,475,002; 10,445,708; 10,438,174; 10,417,615; 10,401,411; 10,269,110; 10,127,647; 10,055,798; 9,885,672; 9,881,284; 8,200,533; 8,195,511; and 7,881,965; U.S. patent application Ser. No. 17/645,039, Ser. No. 17/445,799; Ser. No. 17/445,821; Ser. No. 17/445,799; Ser. No. 17/445,178; Ser. No. 17/445,158; Ser. No. 17/445,083; Ser. No. 17/445,082; Ser. No. 17/125,994; Ser. No. 16/794,009; Ser. No. 16/788,169; Ser. No. 16/788,153; Ser. No. 16/719,699; Ser. No. 16/794,009; Ser. No. 16/534,741; Ser. No. 15/057,707; Ser. No. 14/967,183; Ser. No. 14/964,963; Ser. No. 14/663,331; Ser. No. 14/660,768; Ser. No. 14/598,469; Ser. No. 14/568,051; Ser. No. 14/498,763; Ser. No. 13/794,816; Ser. No. 13/794,814; Ser. No. 13/753,539; Ser. No. 13/733,984; Ser. No. 13/705,252; Ser. No. 13/693,032; Ser. No. 13/658,828; Ser. No. 13/658,825; Ser. No. 13/492,835; Ser. No. 13/113,497; U.S. Provisional Application Nos. 63/365,778, 63/267,911, 63/220,890, 63/220,381, 63/127,148, 63/116,020; 63/116,007; 63/088,377; 63/070,207; 63/066,794; 62/950,075; 62/807,165; 62/807,153; 62/804,714; 62/782,947; 62/782,302; 62/332,736; 62/221,510; 62/202,330; 62/169,072; 62/091,426; 62/090,855; 62/076,437; 62/073,847; 62/073,840; 62/059, 132; 62/059,129; 61/607,572; 61/607,548; 61/607,001; 61/606,997; 61/595,154; 61/593,358; 61/583,232; 61/570,309; 61/551,410; 61/472,611; 61/347,635; 61/183,510; and 61/102,304. All the patents and patent applications listed in the preceding sentence and any other patents or patent applications identified herein are incorporated herein by reference in their entireties, except for any subject matter disclaimers or disavowals, and except to the extent that the incorporated material is inconsistent with the express disclosure herein, in which case the language in this disclosure controls. Aspects of the invention can be modified, if necessary, to employ the systems, functions, and concepts of the various references described above to provide yet further embodiments of the invention.

The above Detailed Description of examples and embodiments of the invention is not intended to be exhaustive or to limit the invention to the precise form disclosed above. Although specific examples for the invention are described above for illustrative purposes, various equivalent modifications are possible within the scope of the invention, as those skilled in the relevant art will recognize.

References throughout the foregoing description to features, advantages, or similar language do not imply that all of the features and advantages that may be realized with the present technology should be or are in any single embodiment of the invention. Rather, language referring to the features and advantages is understood to mean that a specific feature, advantage, or characteristic described in connection with an embodiment is included in at least one embodiment of the present technology. Thus, discussions of the features and advantages, and similar language, throughout this specification may, but do not necessarily, refer to the same embodiment.

Furthermore, the described features, advantages, and characteristics of the present technology may be combined in any suitable manner in one or more embodiments. One skilled in the relevant art will recognize that the present technology can be practiced without one or more of the specific features or advantages of a particular embodiment. In other instances, additional features and advantages may be recognized in certain embodiments that may not be present in all embodiments of the present technology.

Any patents, applications, and other references noted above, including any that may be listed in accompanying filing papers, are incorporated herein by reference. Aspects of the invention can be modified, if necessary, to employ the systems, functions, and concepts of the various references described above to provide yet further implementations of the invention.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The teachings of the invention provided herein can be applied to other systems, not necessarily the system described above. The elements and acts of the various examples described above can be combined to provide further implementations of the invention. Some alternative implementations of the invention may include not only additional elements to those implementations noted above, but also may include fewer elements. Further, any specific numbers noted herein are only examples: alternative implementations may employ differing values or ranges.

Although the above description describes various embodiments of the invention and the best mode contemplated, regardless of how detailed the above text, the invention can be practiced in many ways. Details of the system may vary considerably in its specific implementation, while still being encompassed by the present technology. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

From the foregoing, it will be appreciated that specific embodiments of the invention have been described herein for purposes of illustration, but that various modifications may be made without deviating from the spirit and scope of the various embodiments of the invention. Further, while various advantages associated with certain embodiments of the invention have been described above in the context of those embodiments, other embodiments may also exhibit such advantages, and not all embodiments need necessarily exhibit such advantages to fall within the scope of the invention. Accordingly, the invention is not limited, except as by the appended claims.

Although certain aspects of the invention are presented below in certain claim forms, the applicant contemplates the various aspects of the invention in any number of claim forms. Accordingly, the applicant reserves the right to pursue additional claims after filing this application to pursue such additional claim forms, in either this application or a continuing application.

1.-27. (canceled)

28. A kiosk system for verifying an identity of an electronic device for processing to facilitate a secure electronic device processing interaction, the kiosk system comprising:
a kiosk configured to process electronic devices, wherein the kiosk includes a reader device; and
one or more processors operably associated with the kiosk and configured to perform operations including:
obtaining, from the electronic device via the reader device, a sequence of indexes including a first index and a second index different than the first index, wherein the first index and the second index both include a device identifier associated with the electronic device and a first proximity identifier associated with a location of the electronic device;
parsing the first index and/or the second index to obtain the device identifier and the first proximity identifier;
verifying the identity of the electronic device by steps including:
querying a database of evaluated electronic devices with the device identifier to verify whether the electronic device was previously evaluated for processing at the kiosk,
comparing the first proximity identifier parsed from the first index and/or from the second index to a second proximity identifier obtained via the one or more processors to determine whether the first proximity identifier matches the second proximity identifier within a tolerance, and
comparing the second index to the first index to confirm that the second index is based at least partially on the first index; and
upon completion of the steps, proceeding with the processing interaction.

29. The kiosk system of claim 28 wherein the sequence of indexes defines a temporally-changing indicator such that obtaining the sequence of indexes includes obtaining the first index at a first time and obtaining the second index at a second time after the first time.

30. The kiosk system of claim 28 wherein the first proximity identifier includes a timestamp, one or more GPS coordinates, an ambient temperature, and/or an ambient air pressure.

31. The kiosk system of claim 28 wherein the kiosk further includes a sensor configured to obtain the second proximity identifier and wherein the operations further including obtaining the second proximity identifier via the sensor.

32. The kiosk system of claim 28 wherein the reader device includes a camera and wherein obtaining the sequence of indexes includes obtaining, via the camera, a first image of a display screen of the electronic device while the display screen is showing the first index and a second image of the display screen while the display screen is showing the second index.

33. The kiosk system of claim 28 wherein the device identifier is interleaved with the first proximity identifier according to an interleaving algorithm to comprise the first index and/or the second index, and wherein parsing the first index and/or the second index includes deinterleaving the device identifier from the first proximity identifier based at least partially on the interleaving algorithm.

34. The kiosk system of claim 28 wherein the device identifier includes an IMEI number of the electronic device.

35. The kiosk system of claim 28 wherein the one or more processors are one or more processors of the kiosk.

36. A kiosk system for verifying an identity of an electronic device for processing to facilitate a secure electronic device processing interaction, the kiosk system comprising:
a kiosk configured to process electronic devices, wherein the kiosk includes a reader device; and
one or more processors operably associated with the kiosk and configured to perform operations including:
obtaining, from the electronic device via the reader device, a temporally-changing indicator including a device identifier associated with the electronic device and a proximity identifier associated with a location of the electronic device;
verify the temporally-changing indicator by steps including:
querying a database of evaluated electronic devices with the device identifier to verify that the electronic device was previously evaluated for processing at the kiosk; and
verifying, based at least partially on the proximity identifier, that the electronic device is proximate to the reader device; and
upon verifying the temporally-changing indicator, proceeding with processing the electronic device.

37. The kiosk system of claim 36 wherein the reader device includes an antenna and wherein obtaining the temporally-changing indicator includes wireless obtaining, via the antenna, the temporally-changing indicator from the electronic device.

38. The kiosk system of claim 36 wherein the temporally-changing indicator includes a plurality of characters, wherein a first portion of the plurality of characters comprise the device identifier, wherein a second portion of the plurality of characters comprise the proximity identifier, and wherein one or more of the plurality of characters change after a predetermined amount of time.

39. The kiosk system of claim 36 wherein the plurality of characters define a character string, and wherein one or more of the first portion of the plurality of characters are located at a predetermined position within the character string.

40. The kiosk system of claim 36 wherein a third portion of the plurality of characters comprise a previous value of the temporally-changing indicator.

41. The kiosk system of claim 36 wherein the operations further include causing the electronic device to provide the temporally-changing indicator to the reader device.

42. The kiosk system of claim 41 wherein the electronic device includes a display screen and wherein causing the electronic device to provide the temporally-changing indicator to the reader device includes causing the display screen to display the temporally-changing indicator.

43. The kiosk system of claim 36 wherein the device identifier includes an IMEI number of the electronic device.

44. The kiosk system of claim 36 wherein the one or more processors include one or more processors of the kiosk.

45. A method for verifying an identity of an electronic device for processing at a kiosk for processing electronic devices to facilitate a secure electronic device processing interaction, the method comprising:
obtaining, by a reader device of the kiosk and from the electronic device, a sequence of indexes including a first index and a second index different than the first index, wherein the first index and the second index both include a device identifier associated with the electronic device and a first proximity identifier associated with a location of the electronic device;
parsing, via a processor operably associated with the kiosk, the first index and/or the second index to obtain the device identifier and the first proximity identifier;
verifying, via the processor, the identity of the electronic device by steps including:
querying, via the processor, a database of evaluated electronic devices with the device identifier to verify whether the electronic device was previously evaluated for processing at the kiosk,
comparing, via the processor, the first proximity identifier parsed from the first index and/or the second index to a second proximity identifier obtained via the processor to determine whether the first proximity identifier matches the second proximity identifier within a tolerance, and
comparing, via the processor, the second index to the first index to confirm that the second index is based at least partially on the first index; and
upon completion of the steps, proceeding with the processing interaction.

46. The method of claim 45, further comprising transmitting the sequence of indexes to the electronic device.

47. The method of claim 45 wherein obtaining the sequence of indexes includes reading the sequence of indexes from a display screen of the electronic device.

48. The method of claim 45 wherein the first index and/or the second index include a series of characters, wherein a first portion of the series of characters comprise the device identifier, wherein a second portion of the series of characters comprise the first proximity identifier, and wherein parsing the first index and/or the second index includes separating the first portion of the series of characters from the second portion of the series of characters.
